(19) United States
(12) Patent Application Publication
(10) Pub. No.: US 2010/0219561 A1
(43) Pub. Date: Sep. 2, 2010

(54) Method for Producing a Panel or Housing Part of a Vehicle

(76) Inventors: Klaus Pfaffelhuber, Gunzburg (DE); Ludwig Huber, Durbach (DE); Arno Orth, Hamm (DE)

Correspondence Address: KF ROSS PC, 5683 RIVERDALE AVENUE, SUITE 203 BOX 900, BRONX, NY, 10471-0900, US

(21) Appl. No.: 11/921,843

(22) PCT Filed: Jun. 7, 2006
(86) PCT No.: PCT/EP2006/005432

§ 371 Date: Dec. 7, 2007

(30) Foreign Application Priority Data
Jun. 24, 2005 (DE) 102005029729.3

(51) Int. Cl. B29C 43/18

(52) U.S. Cl. 264/320

(57) ABSTRACT

A panel or housing part of a vehicle is made by heating a semifinished product comprising at least one core layer in the form of a nonwoven fabric made of high melting-point and low melting-point fibers above a melting temperature of the low melting-point fibers and shaping the heated semifinished body under pressure in a mold having a mold gap to produce the panel or housing part. The semifinished product is compacted in the mold in some highly densified regions at the edge of the panel or housing part and/or at a spacing from the edge to produce monolithic regions that are substantially free of gas inclusions such that the material of the semifinished product in these highly densified regions flows along the mold gap, while maintaining in other regions the porosity of the nonwoven fabric of the core layer.

### CROSS REFERENCE TO RELATED APPLICATIONS

This application is the US national phase of PCT application PCT/EP2006/005432, filed 7 Jun. 2006, published 4 Jan. 2007 as WO 2007/000225, and claiming the priority of German patent application 102005029729.3 itself filed 24 Jun. 2005, whose entire disclosures are herewith incorporated by reference.

### FIELD OF THE INVENTION

The invention relates to a method of manufacturing a panel or housing part of a vehicle, in particular an underbody panel or a wheel housing panel, where a semifinished product comprising at least one core layer in the form of a nonwoven fabric made of high melting-point and low melting-point fibers is heated above the melting temperature of the low melting-point fibers and is deformed is under pressure in a mold to produce the panel or housing part.

Such a panel may be, for example, an engine compartment panel, underbody panel, or wheel housing panel of a motor vehicle. A corresponding housing part may, for example, also be part of an air duct or an air intake in a motor vehicle. The following description assumes an underbody panel by way of example, although the invention is not limited thereto.

It is known to manufacture an underbody panel out of glass-fiber-reinforced plastic in a pressing process with high internal mold pressure. The glass-fiber reinforcement is typically composed of textile mats or nonwoven fabric mats, or loose glass fibers having the least possible degree of orientation, which are introduced into a plastic matrix made primarily of polypropylene. The semifinished products provided for this purpose are usually plates made of a glass-fiber-reinforced thermoplastics (GMT) or pellet granules (long-fiber thermoplastics (LFT)). The pellet granules are composed of a glass-fiber filament bundle approximately 20 mm in length that is encased by a polypropylene shell.

Before the pressing, the plates are heated in a heating furnace, or the LFT granulates are melted in a plasticizer and then placed in the open mold of a press. The panels manufactured in this manner have a solid, monolithically compacted structure, and typically have a thickness of approximately 1.5 mm to 2.5 mm and a weight per unit area of approximately 2000 g/m². The maximum component size that is currently possible is approximately 1.0 m² to 1.5 m², since very high pressing pressures of approximately 200 to 300 bar are necessary, and a pressing force greater than 3000 t is entails high equipment costs. In this method it is particularly advantageous that even complex shapes such as webs, domes, or air ducts that sometimes have large, abrupt changes in shape may be achieved, and the panel has high stability. However, it is disadvantageous that the panel is relatively heavy and has only slight acoustic damping properties.

New production methods allow lighter and larger-area panels to be manufactured using a substantially lower pressing pressure. To this end, a nonwoven fabric mat made of glass fibers and plastic fibers, for example polypropylene or polyester, is provided as the semifinished product, and is covered on both sides with two plastic cover films, likewise made of polypropylene, for example, or cover nonwoven fabrics made of glass fibers and plastic fibers, for example polypropylene (low-weight reinforced thermoplastics (LWRT)). The core layer of this sandwich structure has the characteristic of expanding or so-called “lofting” in the direction of its thickness when heated, due to the release of internal tensions in the high melting-point fibers. Using this lofted material having an overall starting thickness of approximately 4 mm to approximately 10 mm, the edge region may be compactly pressed (fully consolidated) by means of a suitable mold design, while in the remaining region the porous structure of the nonwoven fabric core having the cover films may be maintained. This structure results in components having high intrinsic rigidity and a relatively low weight per unit area of less than 1500 g/m². By suitable selection of the porosity of the core and cover layers it is also possible to integrate an acoustic damping function into the panel. Since in this method it is not necessary to shape the mold is cavity by means of a flowing mass, this results in significantly lower pressing pressures of approximately 10 bar, and pressing may be easily performed using clamping surfaces of 4 m² and greater. A disadvantage of this method, however, is that the formation of reinforcing structures such as webs, etc., if possible at all, is very limited. In addition, the panel thus produced is relatively brittle and tends to break when subjected to localized stress. Furthermore, in particular for an underbody panel it has been shown that the cover layers may separate from the core layer when the underside of the vehicle contacts the ground in off-road travel.

### OBJECT OF THE INVENTION

An object of the invention is to provide a simple method of manufacturing a panel or housing part for a vehicle, in particular for an underbody panel, sound insulation capsule panel, or wheel housing panel, which is relatively light, for which complex shapes may also be provided, and that reliably withstands stresses during operation of the vehicle.

### SUMMARY OF THE INVENTION

This object is achieved according to the invention by use of the method wherein the semifinished product is compacted in the mold in a plurality of highly densified regions at the edge of the panel or housing part and/or in the center region thereof at a spacing from the edge to produce monolithic regions that are substantially free of gas or air inclusions, while in other regions the porosity of the nonwoven fabric of the core layer is maintained. The highly densified regions are pressed until the material of the semifinished product in these regions flows along a mold gap. The highly densified regions may be achieved by suitable dimensioning of is the mold gap so that the material in these regions is fully consolidated during the pressing procedure, and the compact, monolithic regions—for example blocks or plate portions—essentially free of gas or air inclusions are formed in these highly densified regions. The material of the semifinished product in these highly densified regions is over compressed and begins to flow along the mold gap (extrusion). In the highly densified regions produced by extrusion, as a result of the extrusion process complex shapes such as sharp-edged bends, ribs, beads, or the like may be formed that otherwise could not be produced from the present starting material.

In one refinement of the invention, the semifinished product may be compacted in the mold in some strongly densified regions at the edge of the panel or housing part and/or at a spacing from the edge to likewise produce monolithic regions that are substantially free of gas inclusions, the pressing pressure being dimensioned so that the material of the semifinished product is fully consolidated yet does not flow along the mold gap. In contrast to the highly densified regions produced by extrusion, the strongly densified regions are acted on by slightly lower pressure and are produced by molding. In this manner the referenced refinement of the method according to the invention may be used to manufacture a panel or housing part of a vehicle that has three different regions: the slightly compressed porous regions, the strongly densified regions in which the material does not flow, and the highly densified regions in which the material flows along the mold gap.

The term “free of gas inclusions” means that no gas or air is bubbles are present in the strongly densified regions and in the highly densified regions. However, since in practice very small gas or air inclusions may remain in the material, the term “essentially free of gas inclusions” should be understood such that the density of the strongly densified or highly densified regions is a maximum of 3%, and in particular a maximum of 1%, below the theoretically achievable target density which results when the materials are fully compacted.

The strongly densified and/or the highly densified regions essentially determine the stone resistance and impact resistance of the panel, and are preferably provided in the sections of the panel that are subjected to particularly high stresses. Fastening points, webs, and also nozzles may be provided or mounted in the strongly densified and/or the highly densified regions. The porous regions between the strongly densified and/or the highly densified regions impart good sound absorption properties to the panel, and reduce the overall weight of the panel while simultaneously increasing the rigidity, compared to a conventional compact plate of the same dimensions.

The core layer is formed from a nonwoven fabric made of high melting-point and low melting-point fibers. The high melting-point fibers of the core layer may be glass fibers or polyester fibers, while the low melting-point fibers of the core layer are preferably composed of polypropylene or polyester.

The high melting-point fibers of the core layer may have a fiber length from 5 mm to 100 mm, in particular from 20 mm to 50 mm, and a fiber thickness from 5 μm to 50 μm, in particular from 15 μm to 20 μm.

The low melting-point fibers of the core layer may also have a fiber length from 5 mm to 100 mm, in particular from 20 mm to 50 mm.

It is preferred that the core layer has a weight per unit area of 100 g/m² to 3000 g/m², in particular 500 g/m² to 1500 g/m². In practical tests, a core layer having a weight per unit area ranging in particular from 800 g/m² to 1200 g/m² and in particular 1000 g/m² has proven to be advantageous.

The semifinished product is preferably preheated, thereby expanding (rising) the core layer in the direction of its thickness or lofting.

The semifinished product may comprise only the core layer, or alternatively, the core layer of the semifinished product may be provided with a cover layer at least on one side, in particular on both sides. Such a sandwich structure significantly increases the rigidity of the component and protects the core layer from water and stone impacts.

In one preferred embodiment of the invention, the cover layer or cover layers are formed in each case from a nonwoven fabric made of high melting-point and low melting-point fibers. The high melting-point fibers of the cover layer may be glass fibers or polyester fibers, while the low melting-point fibers of the cover layer may be composed of polypropylene or polyester. The high melting-point fibers and/or the low melting-point fibers of the cover layer preferably have a fiber length from 5 mm to 100 mm, in particular from 20 mm to 50 mm. The high melting-point fibers of the cover layer should have a fiber thickness from 5 μm to 50 μm, in particular from 15 μm to 25 μm.

Each cover layer preferably has a weight per unit area in a range of 100 g/m² to 1000 g/m², in particular 200 g/m² to 700 g/m². In practice, a weight per unit area of 400 g/m² to 500 g/m² has proven to be practical.

In particular when glass fibers are used in the cover layer, there is a risk that the glass fibers may project from the panel in its finished state. To avoid this, in one refinement of the invention an outer face of the cover layer may be provided with a protective layer that is preferably formed from an additional thin nonwoven fabric made of a high melting-point plastic fiber, for example polyester, having a weight per unit area of 10 g/m² to 30 g/m².

Instead of a nonwoven fabric, at least one of the cover layers may alternatively be formed by an aluminum foil that should preferably be perforated for reasons of sound absorption. The aluminum foil is affixed to the core layer by providing on the side thereof facing the core layer an adhesive layer that is preferably made of the same material as the low melting-point fibers of the core layer. The adhesive layer preferably has a thickness between 1 μm and 100 μm, preferably between 1 μm and 30 μm, while the aluminum foil preferably has a thickness between 10 μm and 300 μm, in particular between 50 μm and 150 μm.

In a further alternative embodiment, one or both of the cover layers may be formed from a plastic film that preferably is made of the same material as the low melting-point fibers of the core layer. The plastic film of the cover layer should have a weight per unit area from 50 g/m² to 500 g/m², in particular from 100 g/m² to 300 g/m².

### BRIEF DESCRIPTION OF THE DRAWING

Further details and features of the invention are shown in the following description of embodiments with reference to the drawings, which show the following:

FIG. 1a shows a first embodiment of the semifinished product;

FIG. 1b shows a second embodiment of the semifinished product;

FIG. 1c shows a third embodiment of the semifinished product;

FIG. 2 shows the semifinished product before preheating in a heating station;

FIG. 3 shows the semifinished product after the preheating;

FIG. 4 shows the transfer of the semifinished product from the heating station to a mold of a press;

FIG. 5 shows the semifinished product in the press before the mold is closed;

FIG. 6 shows the semifinished product during closing of the mold;

FIG. 7 shows the situation with the mold completely closed;

FIG. 8 shows the finished panel after the mold is opened; and

FIG. 9 is an enlarged illustration of the finished panel.

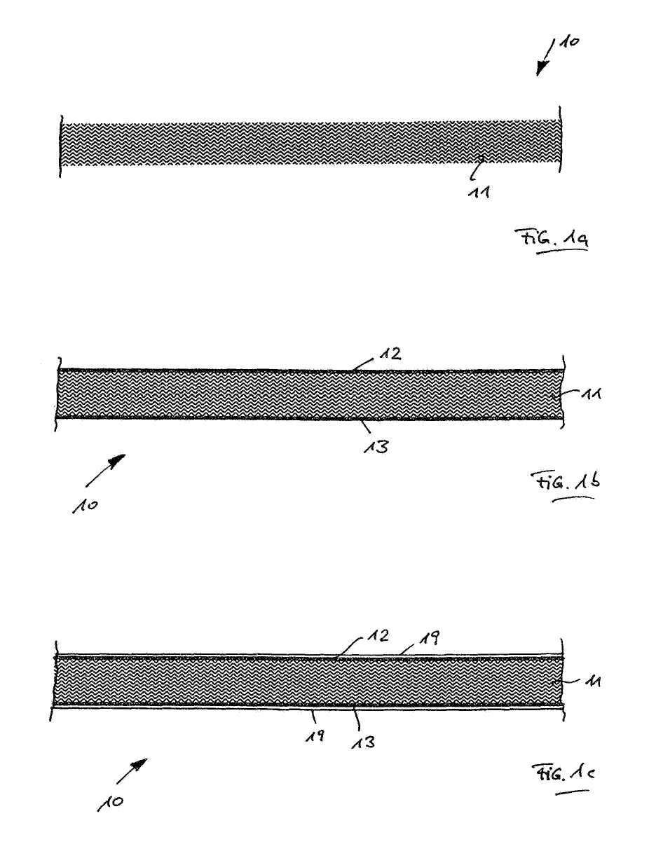

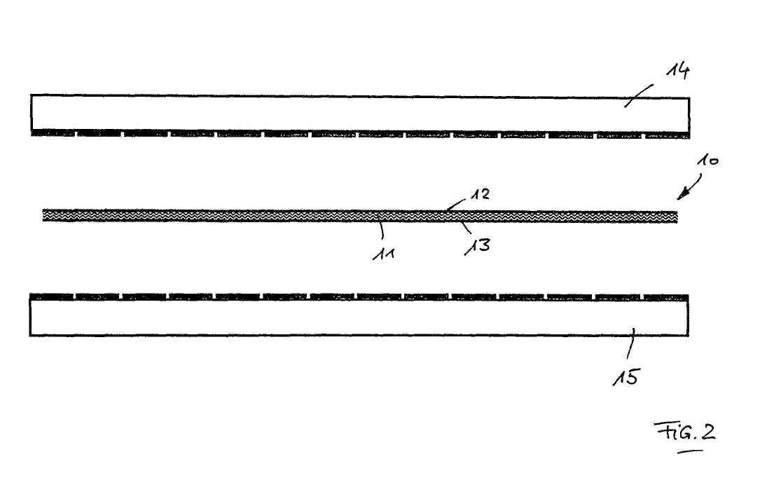

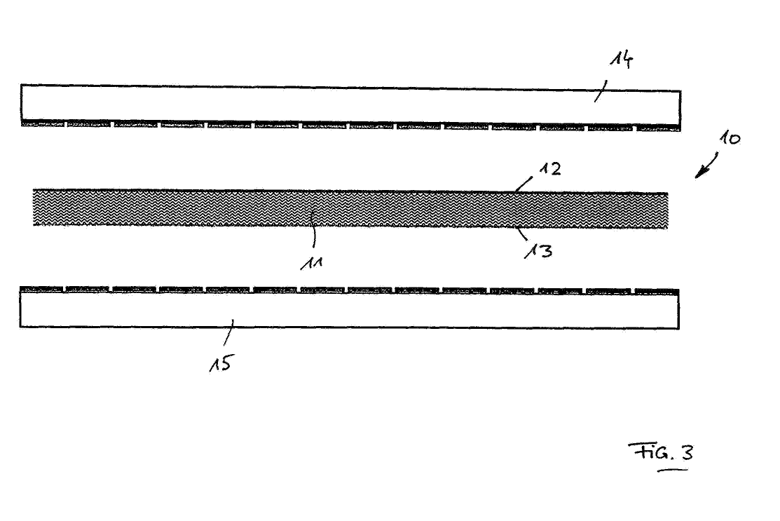

FIGS. 1a, 1b, and 1c show possible alternatives of a semifinished product 10 that is shaped into a panel by use of the method according to the invention.

### SPECIFIC DESCRIPTION

The semifinished product 10 according to FIG. 1a comprises only a core layer 11 in the form of a nonwoven fabric made of high melting-point glass fibers and low melting-point polypropylene fibers that are formed into a nonwoven fabric in a customary manner and optionally needled together. The core layer 11 has a weight per unit area of approximately 1500 g/m².

FIG. 1b shows a refinement of the semifinished product according to FIG. 1a, the core layer 11 on both its upper side and lower side being provided with respective upper and lower cover layers 12 and 13. The cover layers 12 and 13 may each be a plastic film made of polypropylene. At least one of the cover layers 12 and 13 may also be formed from a thin aluminum foil.

However, it is preferred that both cover layers 12 and 13 are likewise a nonwoven fabric made of high melting-point glass fibers and low melting-point polypropylene fibers, the cover layers 12 and 13 having a weight per unit area of approximately 450 g/m².

Due to the sandwich structure and the resultant increased stability, in this embodiment the core layer 11 may have a lower weight per unit area of approximately 800 g/m² to 1200 g/m².

When each of the cover layers 12 and 13 is a nonwoven fabric made of high melting-point glass fibers, it may be practical to provide the outer faces of each of the cover layers 12 and 13 with a thin protective layer 19, as illustrated in FIG. 1c. The protective layer 19 is preferably composed of a nonwoven fabric made of high melting-point plastic fibers, in particular polyester.

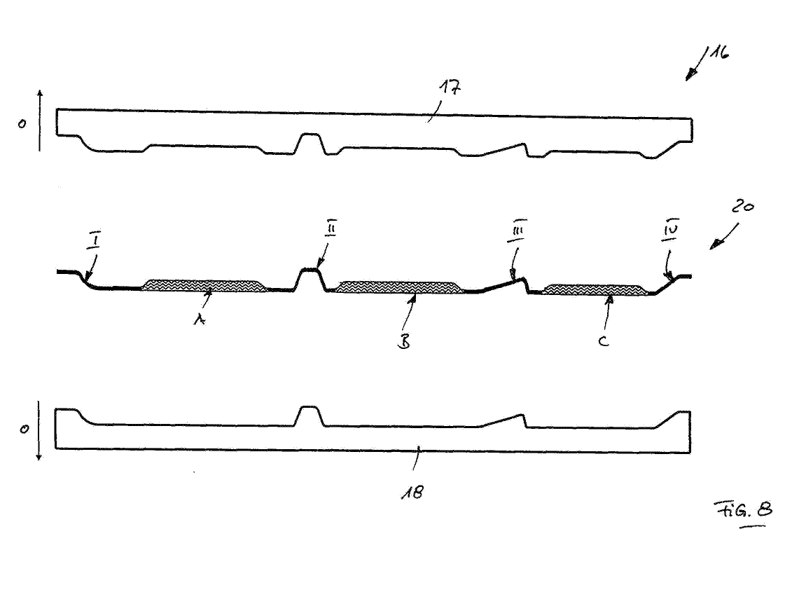

FIGS. 2 through 8 show by way of example the stepwise is shaping of the semifinished product 10 into a panel 20. The semifinished product 10 has the structure illustrated in FIG. 1b, and has a core layer 11 in the form of a nonwoven fabric made of glass fibers and polypropylene fibers, as well as a respective cover layer 12 and 13 on each side, each cover layer likewise being formed from a nonwoven fabric made of glass fibers and polypropylene fibers.

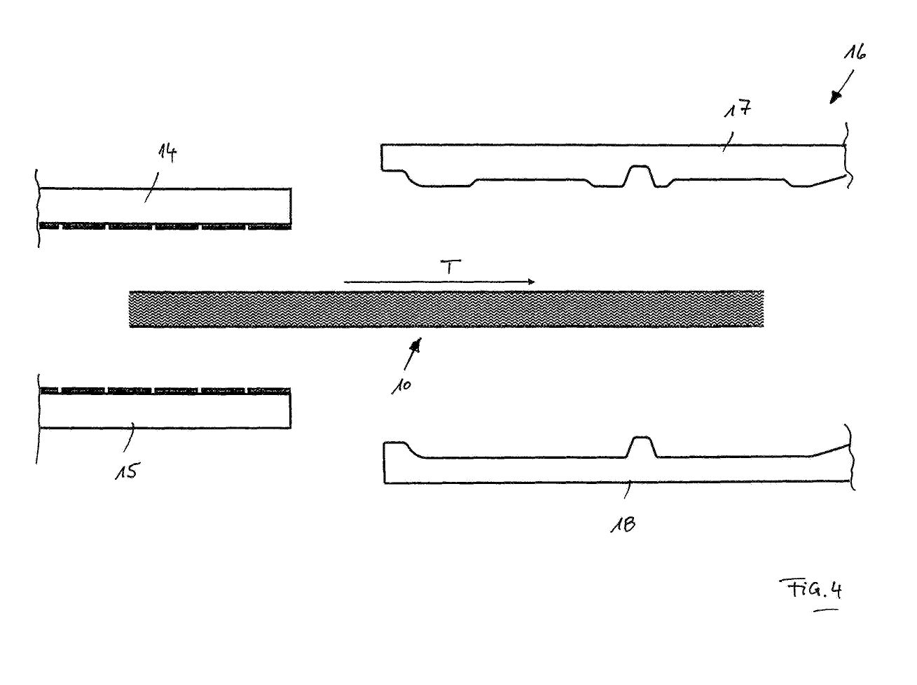

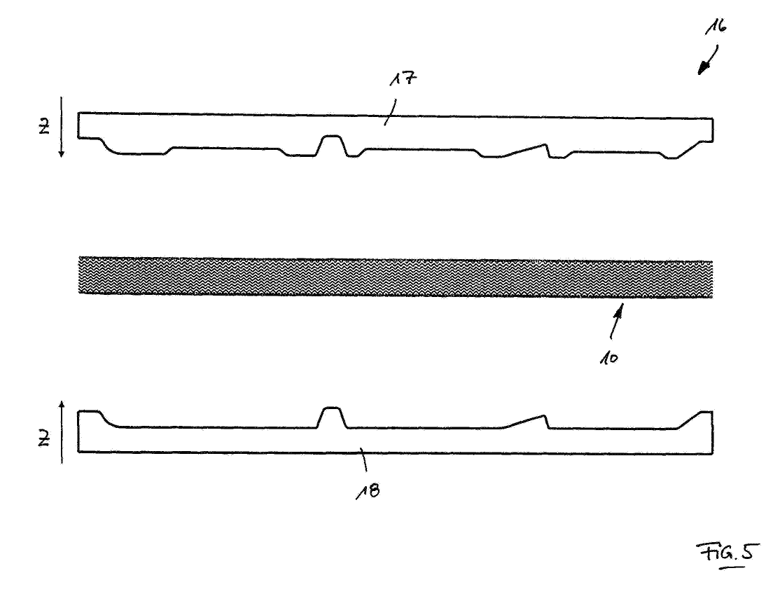

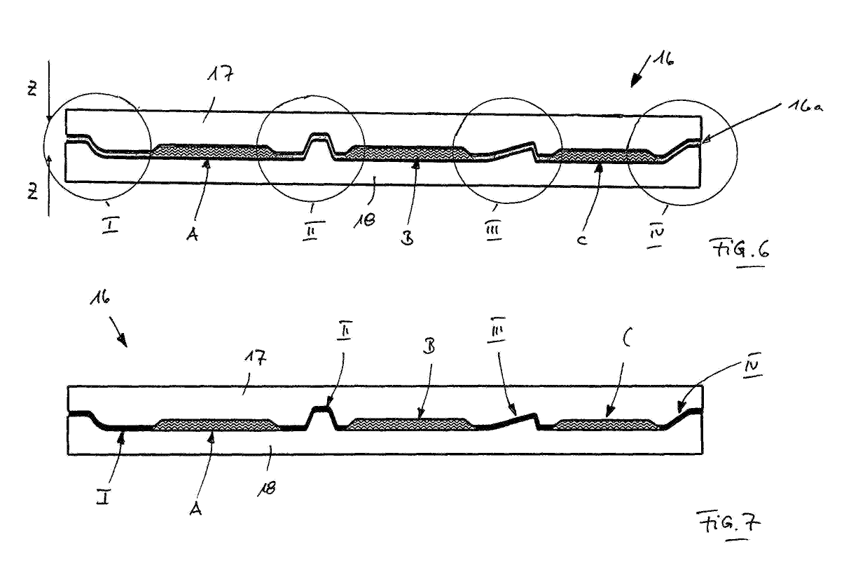

According to FIG. 2, the semifinished product 10 is first preheated in a heating station between two heat sources, i.e. radiant heaters, 14 and 15. This causes the core layer 11 to expand or loft in the direction of its thickness, as illustrated in FIG. 3. The lofted semifinished product 10 is then transferred from the heating station to a mold 16 of a press (see arrow T in FIG. 4), so that the semifinished product is positioned between an upper mold half 17 and a lower mold half 18, as illustrated in FIG. 5. The mold 16 is then closed (arrows Z in FIG. 5), thereby deforming the semifinished product 10 into the panel.

As shown in particular in FIG. 6, a mold gap 16a formed between the upper mold half 17 and the lower mold half 18 is defined such that in the edge region of the panel to be formed (regions I and IV in FIG. 6) as well as in the center regions at a spacing from the edge (regions II and III in FIG. 6) the semifinished product 10 is compressed with a significantly higher pressure than in other regions A, B, and C positioned therebetween. In the regions A, B, and C of low compression between regions I, II, III, and IV, the porosity of the nonwoven fabric of the core layer 11] is maintained, and the cover layers 12 and 13 are only bonded to the core layer 11 by pressure and heat (see FIG. 9). In the strongly densified regions I, II, III, and IV, the semifinished product 10 is shaped into monolithic regions essentially free of gas inclusions, for example into blocks or solid plate portions. Some of the strongly densified regions, i.e. in the illustrated example, regions II and III at a spacing from the edge, are highly densified, i.e. more strongly compressed than the other strongly densified regions I and IV. The pressure is increased until the material of the semifinished product 10 in the highly densified regions II and III begins to flow longitudinally along the mold gap 16a. These more highly compacted highly densified regions II and III are thus produced by an extrusion process, while the other strongly densified regions I and IV are compacted solely by pressure, and the material at that location does not flow along the mold gap 16a, i.e. are produced strictly by mold compression.

Regions I, II, III, and IV, which preferably are joined together and thus form a frame structure, essentially determine the impact resistance of the panel, while the porous regions A, B, and C therebetween provide favorable sound absorption properties and, due to their sandwich structure, high panel stability.

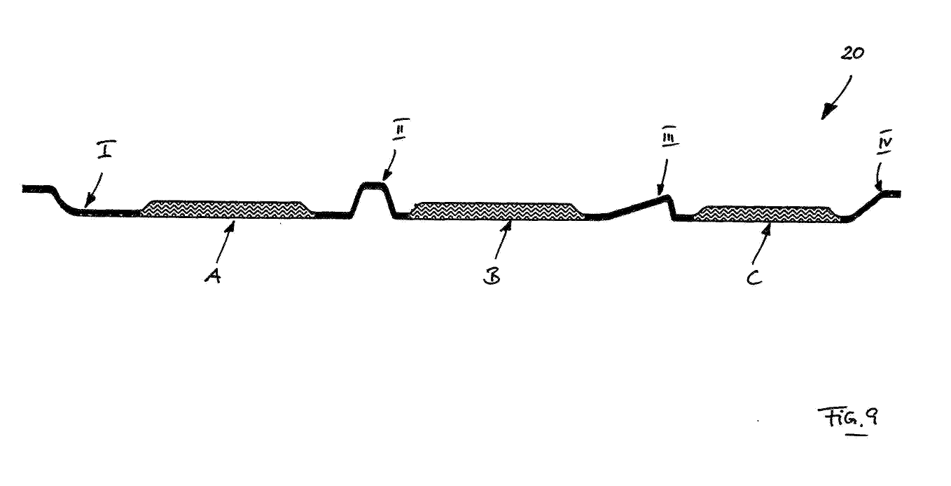

After the panel has cooled sufficiently and thus has adequate intrinsic stability, the mold 16 is opened (arrow O in FIG. 8), whereupon the panel 20 may be removed.

The finished panel 20 is illustrated in enlarged form in FIG. 9. FIG. 9 shows the structure of the panel 20, comprising three differently compressed types of regions, namely, the porous slightly compressed regions A, B, and C, the strongly densified regions I and IV at the edge of the panel 20 that are produced by molding, and the highly densified regions II and III in the center is of the panel 20 that are produced by extrusion.

1. In a method for manufacturing a panel or housing part of a vehicle, wherein a semifinished product comprising at least one core layer in the form of a nonwoven fabric made of high melting-point fibers and low melting-point fibers is heated above a melting temperature of the low melting-point fibers and is shaped under pressure in a mold having a mold gap to produce the panel or housing part, the improvement comprising the step of
compacting the semifinished product in the mold in a plurality of highly densified regions at the edge of the panel or housing part and/or at a spacing from the edge to produce monolithic regions that are substantially free of gas inclusions such that the material of the semifinished product in these highly densified regions flows along the mold gap, while maintaining in other regions the porosity of the nonwoven fabric of the core layer.

2. The method according to claim 1, further comprising the step of
compacting the semifinished product in the mold in some strongly densified regions at the edge of the panel or housing part and/or at a spacing from the edge to produce monolithic regions that are substantially free of gas inclusions, while preventing the material of the semifinished product in these regions from flowing along the mold gap.

3. The method according to claim 1 wherein the high melting-point fibers of the core layer are glass fibers or polyester fibers.

4. The method according to claim 1 wherein the low melting-point fibers of the core layer are composed of polypropylene or polyester.

5. The method according to claim 1 wherein the high melting-point fibers of the core layer have a fiber length from 5 mm to 100 mm mm.

6. The method according to claim 1 wherein the high melting-point fibers of the core layer have a fiber thickness from 5 μm to 50 μm.

7. The method according to claim 1 wherein the low melting-point fibers of the core layer have a fiber length from 5 mm to 100 mm.

8. The method according to claim 1 wherein the core layer has a weight per unit area of 100 g/m².

9. The method according to claim 1 wherein the core layer is lofted transversely in the direction of its thickness during heating.

10. The method according to claim 1 wherein the core layer of the semifinished product is provided with a cover layer at least on one side.

11. The method according to claim 10 wherein the core layer of the semifinished product is provided with a cover layer on both sides.

12. The method according to claim 10 wherein the cover layer is a nonwoven fabric made of high melting-point and low melting-point fibers.

13. The method according to claim 10 wherein the high melting-point fibers of the cover layer are glass fibers or polyester fibers.

14. The method according to claim 10 wherein the low melting-point fibers of the cover layer are composed of polypropylene or polyester.

15. The method according to claim 10 wherein the high melting-point fibers of the cover layer have a fiber length from 5 mm to 100 mm.

16. The method according to claim 10 wherein the high melting-point fibers of the cover layer have a fiber thickness from 5 μm to 50 μm.

17. The method according to claim 10 wherein the low melting-point fibers of the cover layer have a fiber length from 5 mm to 100 mm.

18. The method according to claim 10 wherein the cover layer has a weight per unit area of 100 g/m² to 1000 g/m².

19. The method according to claim 10 wherein an outer face of the cover layer is provided with a thin protective layer.

20. The method according to claim 19 wherein the protective layer is a nonwoven fabric of high melting-point fibers and has a weight per unit area of 10 g/m² to 30 g/m².

21. The method according to claim 10 wherein the cover layer is made of an aluminum foil.

22. The method according to claim 21 wherein the aluminum foil is perforated.

23. The method according to claim 21 wherein the aluminum foil has an adhesive layer on the core layer side.

24. The method according to claim 23 wherein the adhesive layer is made of the same material as the low melting-point fibers of the core layer.

25. The method according to claim 23 wherein the adhesive layer has a thickness between 1 μm and 100 μm.

26. The method according to claim 21 wherein the aluminum foil has a thickness between 10 μm and 300 μm.

27. The method according to claim 10 wherein the cover layer is a plastic film.

28. The method according to claim 27 wherein the plastic film of the cover layer is made of the same material as the low melting-point fibers of the core layer.

29. The method according to claim 27 wherein the plastic film of the cover layer has a weight per unit area of 50 g/m² to 500 g/m².

30. The method according to claim 1 wherein the mold gap is dimensioned such that in the highly densified regions the semifinished product is compressed with a higher pressure than in the other regions.

31. In a method for manufacturing a panel or housing part of a vehicle wherein a semifinished product comprising at least one core layer in the form of a nonwoven fabric made of high melting-point fibers and low melting-point fibers is heated above a melting temperature of the low melting-point fibers and is shaped under pressure in a mold to produce the panel or housing part, the improvement comprising the step of
compressing in some highly densified regions the semifinished product with a higher pressure than in other regions and thereby compacting the semifinished product in the mold in the highly densified regions at the edge of the panel or housing part and/or at a spacing from the edge to produce monolithic regions that are substantially free of gas inclusions such that the material of the semifinished product in these highly densified regions flows along a mold gap formed between an upper mold half and a lower mold half of the mold, while preventing changes in the other regions of the porosity of the nonwoven fabric of the core layer.

32. The method defined in claim 31 wherein the mold gap is dimensioned to accommodate the semifinished product during molding such that in the highly densified regions the semifinished product is compressed with a higher pressure than in the other regions.
